(19) United States
(12) Patent Application Publication
(10) Pub. No.: US 2013/0196222 A1
(43) Pub. Date: Aug. 1, 2013

(54) BUTTON CELL PROTECTED AGAINST SHORT CIRCUIT

(71) Applicants: Rolf Brenner, Ellwangen (DE); Eduard Pytlik, Ellwangen (DE)

(72) Inventors: Rolf Brenner, Ellwangen (DE); Eduard Pytlik, Ellwangen (DE)

(73) Assignee: VARTA MICROBATTERY GMBH, Ellwangen (DE)

(21) Appl. No.: 13/635,945

(22) PCT Filed: Mar. 17, 2011
(86) PCT No.: PCT/EP2011/054028

§ 371 Date: Nov. 9, 2012

(30) Foreign Application Priority Data
Mar. 22, 2010 (DE) 10 2010 012 977.1

(51) Int. Cl. H01M 2/08

(52) U.S. Cl. CPC H01M 2/08
USPC 429/185; 29/623.2

(57) ABSTRACT

A button cell with a housing includes a cup part and a cover part, which each have a floor region and a lateral surface region adjacent thereto and extending up to a first cut edge. A positive and a negative electrode, separated by a separator, are arranged in the housing. The cup part and the cover part are physically separated and electrically isolated from one another by a film seal, wherein the film seal surrounds the outer side of the cover part in the lateral surface region like a collar and is turned over the cut edge of the cover part inwardly. The film seal in this case forms, together with the separator and the cover part, a closed cavity in which the negative electrode is arranged.

### RELATED APPLICATIONS

This is a §371 of International Application No. PCT/EP2011/054028, with an inter-national filing date of Mar. 17, 2011 (WO 2011/117132 A1, published Sep. 29, 2011), which is based on German Patent Application No. 10 2010 012 977.1, filed Mar. 22, 2010, the subject matter of which is incorporated by reference.

### TECHNICAL FIELD

This disclosure relates to a button cell with a housing comprising a bowl-shaped cup part and a bowl-shaped cover part, which are separated from one another physically and electrically isolated from one another by a film seal to protect against short circuiting.

### BACKGROUND

Button cells generally have a housing comprising two housing half-parts, namely a cup part and cover part. These parts can be produced as stamped and drawn parts from nickel-plated deep-drawn sheet metal, for example. Usually, the cup part has positive polarity and the cover part negative polarity. A wide variety of electrochemical systems can be contained in the housing, for example, zinc/manganese dioxide, primary and secondary lithium systems or secondary systems such as nickel/cadmium or nickel/metal hydride.

The liquid-tight sealing of such cells is performed by flanging the edge of the cup part, for example. A plastics ring arranged between the cup part and the cover part in this case generally at the same time acts as a seal and as an insulator, which separates the cup part physically from the cover part and electrically isolates the parts. Such button cells are known, for example, from DE 3113309.

The sealing elements required for button cells are conventionally produced using the injection molding method, for example, from polyamides. The injection molding dies required for this purpose are very complex and expensive. Furthermore, it is practically impossible to produce sealing elements with walls with a thickness of less than 0.2 mm using the injection molding process, with the result that the known seals require a comparatively large volume, in particular in the case of very small button cells and, therefore, impair the capacity utilization of the cell.

DE 19647593 describes the use of a sealing element produced by deep drawing from a film. A cup-shaped molding is drawn with a vacuum from a heated film by a female drawing die and a male molding die. Polyamides are cited as the preferred film material. The deformation takes place in one or more working steps, depending on the desired diameter/height ratio. Then, punching is performed in the floor region of the cup-shaped molding produced by deep-drawing by a blanking punch and a blanking sleeve. The sealing element is fitted on a cover part, which can then be inserted into a cup part. Since film seals produced in this way have only very small thicknesses, the resultant button cells have optimized capacity. The use of film seals offers clear advantages in this regard over the conventional use of seals consisting of injection-molded parts.

The above-described element is based on the development described in DE 19647593. DE '593 addresses the problem of providing button cells characterized by optimized capacity, a simple design and efficient separation of the positive and negative electrodes within the button cell housing.

### SUMMARY

We provide a button cell including a bowl-shaped cup part with a first planar floor region and a first lateral surface region adjacent thereto and extending up to a first cut edge, a bowl-shaped cover part with a second planar floor region and a second lateral surface region adjacent thereto and extending up to a second cut edge, wherein the cover part, leading with the cut edge, is inserted into the cup part and forms with the cup part a closed housing, a seal which separates the cup part and the cover part physically from one another and electrically insulates the parts from one another, a positive electrode in electrical contact with the planar floor region of the cup part, a negative electrode in electrical contact with the planar floor region of the cover part, and a separator between the positive and negative electrodes which separates the electrodes, wherein the seal includes a film seal surrounding an outer side of the cover part in the lateral surface region as a collar and is turned over the cut edge of the cover part so far inwardly that, together with the separator and the cover part, the film seal forms a closed cavity in which the negative electrode is arranged.

We also provide a method for manufacturing the button cell including providing a bowl-shaped cover part with a planar floor region and a lateral surface region adjacent thereto and extending up to a cut edge, providing a bowl-shaped cup part with a first planar floor region and a first lateral surface region adjacent thereto and extending up to a first cut edge, providing a bowl-shaped cover part with a second planar floor region and a second lateral surface region adjacent thereto and extending up to a second cut edge, applying a film seal to the outer lateral surface of the cover part such that the film seal surrounds the outer side of the cover part in the lateral surface region as a collar and a circumferential section of the film seal protrudes beyond the cut edge of the cover part, turning a section of the film seal which protrudes beyond the cut edge of the cover part around the cut edge of the housing half-part into an interior portion of the cover part, introducing negative electrode material into the cover part, positioning a separator in the cover part such that the separator forms, with the film seal and the cover part, a closed cavity in which the negative electrode material is enclosed, optionally introducing positive electrode material into a bowl-shaped receptacle formed by the film seal and the separator for the positive electrode, inserting the cover part into the cup part, and sealing the cell.

### BRIEF DESCRIPTION OF THE DRAWINGS

FIG. 1 shows, in cross section, a preferred example of a button cell 100.

FIG. 2 shows, in cross section, a preferred example of a button cell 200.

### DETAILED DESCRIPTION

Our button cell comprises a bowl-shaped cup part and a bowl-shaped cover part. The cup part comprises a first planar floor region adjoined by a lateral surface region extending up to a first cut edge. The cover part comprises a second planar floor region adjoined by a second lateral surface region extending up to a second cut edge. The cover part, with the cut edge leading, is inserted into the cup part and forms with the cup part a closed housing. The floor regions of the cup part and the cover part are arranged in parallel to one another when the button cell is completely fitted and, in the use state, form the upper and lower side of the button cell, at which current is generally withdrawn by a load. The lateral surface regions form the side walls of the button cell. The cup part and the cover part are separated physically from one another and isolated electrically from one another by a seal. In addition to its isolating function, this seal generally also ensures that the housing comprising the cover part and the cup part is sealed in a fluid-tight manner.

A positive and a negative electrode are located within the housing. In this case, the positive electrode is in electrical contact with the planar floor region of the cup part, and the negative electrode is in electrical contact with the planar floor region of the cover part. The positive and negative electrodes, in the same way as the cup part and the cover part, should not come into direct touching contact with one another to avoid a short circuit. For this reason, a separator is positioned between the positive and the negative electrode, the separator separating the electrodes physically from one another. The separator preferably forms a flat layer within the housing, the layer being aligned substantially parallel to the planar floor regions of the cup and cover parts, or comprises at least one such layer. The separator thus divides the housing interior into two compartments, in which the positive and negative electrodes are arranged, separately from one another.

Preferably, ion-permeable materials such as porous membranes consisting of plastics or nonwovens, are used as a separator. Corresponding separator materials suitable for button cells are known.

In our button cell, a film seal is used as a seal. A film seal is in this case in particular understood to mean a seal formed from a molding produced by deep-drawing from a plastics film, in particular a seal as is described in DE 19647593. This film seal, in the case of our button cell, surrounds the outer side of the cover part in the lateral surface region in the manner of a collar, but at the same time has a peripheral section turned around the cut edge of the cover part inwardly. The film seal preferably has a thickness of less than 0.15 mm, particularly preferably of less than 0.1 mm.

Particularly preferably, the circumferential section is turned so far inwardly that it forms, together with the separator and the cover part, a closed cavity in which the negative electrode is arranged (in conventional button cells, this cavity is formed only by the cover part and the separator).

Film seals of button cells are also known, for example, from DE 102007003519, and generally turned just so far about the cut edge of a cell cover that the cut edge is covered completely by the film. This serves to avoid gas development in the housing interior. As mentioned above, the housing parts of button cells often consist of trimetal with the layer sequence nickel, steel and copper, wherein copper generally forms the inner side of the button cell housing. The comparatively base steel layer located between the nickel and copper layers is freely accessible at the cut edge of the button cell cover. There, a gassing phenomena often arises as a consequence of which button cells can leak and be irreparably damaged.

In contrast to this, the film seal of our button cell is generally dimensioned such that it can cover at least relatively large subsections of the inner side of the lateral surface region of the cover part up to a depth at which the separator is positioned or, preferably, bears against the inner walls of the cover part. The film seal therefore ensures, together with the separator, complete and efficient separation of the cathode and anode spaces. Problems with short circuits within the button cell are thus largely eliminated.

Particularly preferably, our button cell is characterized by the fact that the film seal surrounds the separator in the form of a ring and exerts a radial pressure on it (example A). Ideally, the film seal is, for this purpose, in an elastically deformed, in particular elastically expanded state.

Such a state can be achieved by virtue of the diameter and the radius of the inwardly turned section of the film seal being matched in a suitable manner to the diameter and radius of the separator surrounded by the film seal in the form of a ring. To achieve this, the inwardly turned section of the film seal can be heat-treated, for example, with the result that its diameter/radius is reduced by contraction with respect to the diameter/radius of that part of the film seal which surrounds the outer side of the cover part in the lateral surface region. Preferably, the diameter and radius of the turned section after such a treatment decrease starting from the cut edge of the cover part in the direction of the floor region of the cover part. If, at the same time, the diameter/radius of the separator is selected to be large enough, the separator can only be positioned in the button cell with a radial widening and expansion of the turned section. The radially widened section then exerts the mentioned radial pressure on the separator.

It may also be preferable for the separator to be formed and positioned in the housing such that it presses the inwardly turned film seal radially against the inner side of the cover part (example B). This example can represent an extreme case of the mentioned radial widening of the turned section (i.e., example A), but can also be implemented completely independently.

Preferably, the separator is in the form of a disk, in particular in the form of a circular disk. The edges of the disk can widen the film seal radially and/or press the film seal against the inner side of the cover part. In the case of example B, the radius of the disk preferably corresponds substantially to the inner radius of the cover part in the lateral surface region or even exceeds this, preferably by between 1% and 25%. In the case of example A, the radius of the disk is preferably at least 90% of the inner radius of the cover part and is at most 25% above this. In the case of example B, the inwardly turned section of the film seal has at least a subregion in which its radius is smaller than the maximum radius of the separator.

Particularly preferably, the separator can be in the form of a bowl with a planar base area in the form of a disk and a circumferential edge region adjacent thereto and aligned preferably perpendicular to the base area. The opening edge of the bowl preferably points in the direction of the floor region of the cup part, while the base area is preferably aligned parallel to the planar floor and cover regions of the cup and cover part. Preferably, such a separator has its maximum radius in the region of the circumferential edge region.

In the case of example B, the radius of the base area preferably corresponds substantially to the inner radius of the cover part in the lateral surface region. The circumferential edge region preferably bears flat against the inner side of the cover and overlaps with the turned section of the film seal there. Such a bowl-like separator is formed, for example, by using a separator disk whose radius markedly exceeds the inner radius of the cover part and whose edge region folds over, correspondingly when the separator is inserted into the cover part, counter to the insertion direction,

In the case of example A, the radius of the base area preferably undershoots the inner radius of the cover part in the lateral surface region.

The cut edge of the cover part preferably rests in the planar floor region or on the floor of the cup part. Alternatively, the use of a supporting ring is also conceivable, for example, to prevent damage to the film seal at the cut edge of the cover part.

The film seal is preferably a seal consisting of a thermoplastic film, in particular of a material such as polyamide or of polyether ether ketone (PEEK). With respect to other preferred features of the film seal, reference is made to DE 102007003519 and DE 19647593, already mentioned.

The method for producing button cells is used in particular to produce button cells as have been described above.

The method always comprises the following steps:
providing a bowl-shaped cup part and a bowl-shaped cover part, as have been described already above,
applying a film seal to the outer lateral surface of the cover part, with the result that the film seal surrounds the outer side of the cover part in the lateral surface region in the manner of a collar and a circumferential section of the film seal protrudes beyond the cut edge of the cover part,
turning that section of the film seal which protrudes beyond the cut edge of the cover part around the cut edge of the cover part into the interior of the cover part,
introducing negative electrode material into the cover part,
positioning a separator in the cover part such that the separator forms, with the film seal and the cover part, a closed cavity in which the negative electrode material is enclosed,
optionally introducing positive electrode material into the cover part, in particular into a bowl-shaped receptacle formed by the film seal and the separator,
inserting the cover part into the cup part, and
sealing the cell, in particular by flanging.

In relation to the film seal used in a method and the separator, reference can be made to the statements made above in the context of the explanation of the button cell. All conventional electrode materials can be used as electrode materials. Preferably, the negative electrode material is a hydrogen storage alloy, for example, an AB₅ alloy, and the positive electrode material is nickel hydroxide.

Turning that section of the film seal which protrudes beyond the cut edge of the cover part about the cut edge of the cover part into the interior of the cover part can in principle be performed as described in DE 102007003519, i.e., with the aid of a heated punch, for example. The turned section is preferably heated to such a high temperature by the punch or an alternative heat source that contraction occurs and its radius is reduced in comparison with the radius of that part of the film seal which surrounds the outer side of the cover part in the lateral surface region.

As an alternative or in addition, the size of the separator can be selected such that, once it has been positioned in the housing, it presses the turned section of the film seal radially against the inner side of the cover part and/or the section of the film seal is widened such that it exerts a radial pressure on the separator.

In addition to the mentioned steps, the method can also comprise further steps, for example, metering-in of electrolyte which does not have anything to do with the essence of this invention, however.

The methods and the compact batteries will be explained in more detail with reference to the drawings, in which the subjects are illustrated schematically and are described below. At this juncture, explicit reference is made to the fact that all of the optional aspects of the compact batteries or the methods described herein can each be implemented alone or in combination with one or more of the further described optional aspects in one example. The following description of preferred examples is used merely by way of explanation and serves for better understanding and is in no way to be understood as restrictive.

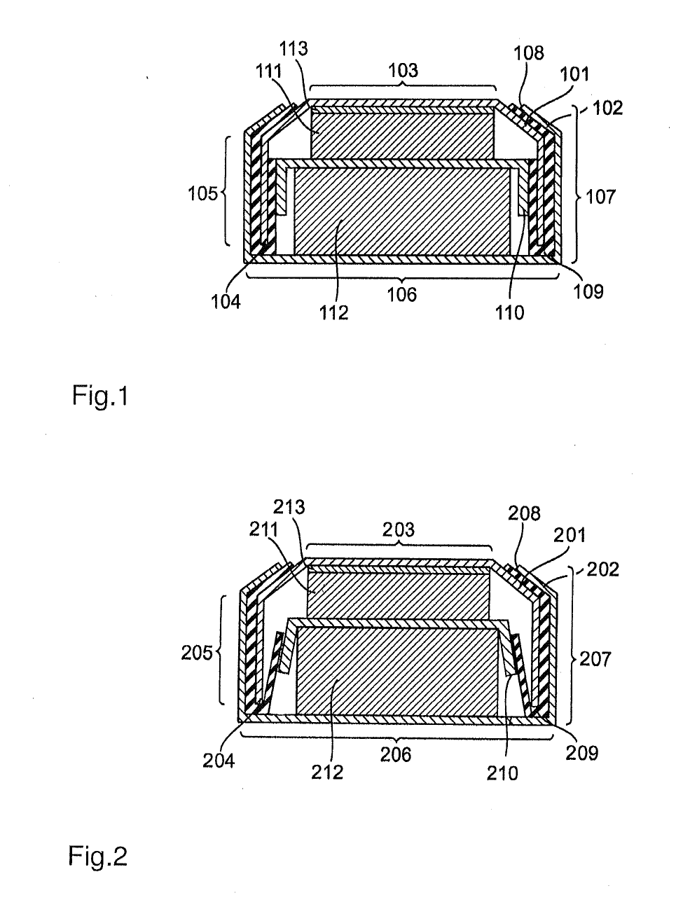

Referring to FIG. 1, a bowl-shaped cover part 101 is inserted into a bowl-shaped cup part 102. The cover part 101 has a planar floor region 103 and a lateral surface region 105 ex-tending up to a cut edge 104. The housing cup 102 has the planar floor region 106 and the lateral surface region 107. The upper part of the housing cup with the cut edge 108 is flanged inwards. This ensures that the cup part 102 and the cover part 101 are held together. The film seal 109 is arranged between the cup part 102 and the cover part 101. This film seal is turned about the cut edge 104 of the cover part 101 into the interior of the cover part and bears against the inner side thereof in the lateral surface region 105. It is fixed there by the separator 110, which is likewise in the form of a bowl. The separator 110 has a base area in the form of a circular disk and a circumferential edge region adjacent thereto and aligned substantially perpendicular to the base area. This edge region presses the film seal 109, which is turned about the cut edge 104 of the cover part 101 into the interior thereof, against the inner side of the cover part.

The described button cell 100 is therefore an example in accordance with the above example B. The separator 110 separates the electrodes 111 and 112 from one another. The electrode 112 is the positive electrode, and the electrode 111 is the negative electrode. A contact spring 113 is arranged between the negative electrode 111 and the cover part 101 to be able to compensate for any changes in volume of the electrodes which may occur. The separator 110, the film seal 109 and the floor region 106 of the cell cup define a closed cavity, in which the positive electrode 112 is arranged. This positive electrode is separated cleanly from the anode space and, therefore, a short circuit is virtually impossible.

Referring to FIG. 2, a bowl-shaped cover part 201 is inserted into a bowl-shaped cup part 202. The cover part 201 has a planar floor region 203 and a lateral surface region 205 extending up to a cut edge 204. The housing cup 202 has the planar floor region 206 and the lateral surface region 207. The upper part of the housing cup with the cut edge 208 is flanged inwards. This ensures that the cup part 202 and the cover part 201 are held together. The film seal 209 is arranged between the cup part 202 and the cover part 201. This film seal is turned about the cut edge 204 of the cover part 201 into the interior of the cover part. Starting from the cut edge of the cover part, the diameter and radius of the section of the film seal which is turned into the interior decrease in the direction of the floor region of the cover part, which can be attributed to a thermal treatment of this section, during which contraction of the film seal took place. The separator 210 has a base area in the form of a circular disk and a circumferential edge region adjacent thereto and aligned substantially perpendicular to the base area. This edge region overlaps partially with the film seal 209 which is turned about the cut edge 204 of the cover part 201 into the interior thereof and exerts a radial pressure on the cover part.

Owing to its diameter, the separator 210 could only be positioned in the cover 201 with a radial widening of that section of the film seal 209 which tapers in the direction of the floor 203 and is turned inwards. The inwardly turned section is under stress correspondingly at least in the region in which it overlaps with the edge region of the separator. The described button cell 200 is therefore an example in accordance with the above example A. The separator 210 separates the electrodes 211 and 212 from one another. The electrode 212 is the positive electrode, and the electrode 211 is the negative electrode. A contact spring 213 is arranged between the negative electrode 211 and the cover part 101 to be able to compensate for any changes in volume of the electrodes which may occur. The separator 210, the film seal 209 and the floor region 206 of the cell cup define a closed cavity, in which the positive electrode 212 is arranged. This cavity is separated cleanly from the anode space and, therefore, a short circuit is virtually impossible.

1. A button cell comprising;
a bowl-shaped cup part with a first planar floor region and a first lateral surface region adjacent thereto and extending up to a first cut edge,
a bowl-shaped cover part with a second planar floor region and a second lateral surface region adjacent thereto and extending up to a second cut edge, wherein the cover part, leading with the cut edge, is inserted into the cup part and forms with the cup part a closed housing,
a seal which separates the cup part and the cover part physically from one another and electrically insulates the parts from one another,
a positive electrode in electrical contact with the planar floor region of the cup part,
a negative electrode in electrical contact with the planar floor region of the cover part, and
a separator between the positive and negative electrodes which separates the electrodes,
wherein the seal comprises a film seal surrounding an outer side of the cover part in the lateral surface region as a collar and is turned over the cut edge of the cover part so far inwardly that, together with the separator and the cover part, the film seal forms a closed cavity in which the negative electrode is arranged.

2. The button cell as claimed in claim 1, wherein the film seal surrounds the separator in the form of a ring and exerts a radial pressure thereon.

3. The button cell as claimed in claim 1, wherein the separator is formed and positioned in the housing such that it presses the film seal, which is turned inwardly, radially against an inner side of the cover part.

4. The button cell as claimed in claim 1, wherein the separator is a disk.

5. The button cell as claimed in claim 1, wherein the separator is a bowl with a disk-shaped planar base area and a circumferential peripheral region adjacent thereto and aligned substantially perpendicular to the base area.

6. The button cell as claimed in claim 1, wherein the cut edge of the cover part rests in the planar floor region of the cup part.

7. The button cell as claimed in claim 1, wherein the film seal is polyamide or PEEK thermoplastic film.

8. A method for manufacturing the button cell comprising:
providing a bowl-shaped cover part with a planar floor region and a lateral surface region adjacent thereto and extending up to a cut edge,
providing a bowl-shaped cup part with a first planar floor region and a first lateral surface region adjacent thereto and extending up to a first cut edge,
providing a bowl-shaped cover part with a second planar floor region and a second lateral surface region adjacent thereto and extending up to a second cut edge,
applying a film seal to the outer lateral surface of the cover part such that the film seal surrounds the outer side of the cover part in the lateral surface region as a collar and a circumferential section of the film seal protrudes beyond the cut edge of the cover part,
turning a section of the film seal which protrudes beyond the cut edge of the cover part around the cut edge of the housing half-part into an interior portion of the cover part,
introducing negative electrode material into the cover part,
positioning a separator in the cover part such that the separator forms, with the film seal and the cover part, a closed cavity in which the negative electrode material is enclosed,
optionally introducing positive electrode material into a bowl-shaped receptacle formed by the film seal and the separator for the positive electrode,
inserting the cover part into the cup part, and
sealing the cell, in particular by means of flanging.

9. The method as claimed in claim 8, further comprising heat-treating the section of the film seal which protrudes beyond the cut edge of the cover part prior to, during and/or after being turned about the cut edge of the housing half-part into the interior of the cover part such that the film seal contracts and reduces its radius.

10. The method as claimed in claim 8, wherein the size of the separator is selected such that it presses the turned circumferential section of the film seal radially against the inner side of the cover part once it has been positioned in the housing and/or the circumferential section of the film seal exerts a radial pressure on the separator.
